(19) United States
(12) Patent Application Publication
(10) Pub. No.: US 2025/0075496 A1
(43) Pub. Date: Mar. 6, 2025

(54) 3D PRINTED EARTH-FIBER STRUCTURES

(71) Applicant: THE TRUSTEES OF COLUMBIA UNIVERSITY IN THE CITY OF NEW YORK, New York, NY (US)

(72) Inventors: Rachel Lola BEN-ALON, New York, NY (US); Olga Beatrice Carcassi, New York, NY (US)

(73) Assignee: THE TRUSTEES OF COLUMBIA UNIVERSITY IN THE CITY OF NEW YORK, New York, NY (US)

(21) Appl. No.: 18/949,094

(22) Filed: Nov. 15, 2024

Related U.S. Application Data
(63) Continuation-in-part of application No. PCT/US2023/022661, filed on May 18, 2023.
(60) Provisional application No. 63/343,507, filed on May 18, 2022.
(60) Provisional application No. 63/467,362, filed on May 18, 2023.
(60) Provisional application No. 63/600,837, filed on Nov. 20, 2023.

(51) Int. Cl. E04C 2/04; B28B 1/00; B33Y 10/00; B33Y 70/10; B33Y 80/00

(52) U.S. Cl. CPC E04C 2/049; B28B 1/001; B33Y 70/10; B33Y 10/00; B33Y 80/00

(57) ABSTRACT

A 3D printed structure is provided. The structure includes a composition formed from a mixture including an earth component, e.g., naturally occurring soil, subsoil, topsoil, clay, a clay-rich soil, sand, silt, an engineered soil formed of sand and clay, etc.; at least one fiber component, e.g., a bast or leaf fiber, including straw, wheat straw, rice straw, rice husk, reed, hay, hemp, kenaf, banana, sisal, fique, flax, jute, etc.; fluid component, e.g., water, oil, acid, etc.; and at least one additive component, e.g., a bio-based additive such as cellulose, a polypeptide such as gelatin, a polysaccharide such as alginate, guar gum, locust bean gum, chitosan, and xanthan gum, and lime, etc. The mixture includes a weight ratio of about 2-50 parts earth; about 5-50 parts fiber; about 25-80 parts fluid; and about 0-10 parts additive. The mixture can be 3D printed into prefabricated building elements, e.g., block-like geometries, monolithic walls, panels, etc.

### CROSS-REFERENCE TO RELATED APPLICATIONS

This application is a continuation-in-part of International Patent Application No. PCT/US2023/022661, filed May 18, 2023, which claims the priority benefit of U.S. Provisional Patent Application No. 63/343,507, filed May 18, 2022, and U.S. Provisional Patent Application No. 63/467,362, filed May 18, 2023, the entirety of each of the disclosures of which are explicitly incorporated by reference herein. This application also claims the benefit of U.S. Provisional Application No. 63/600,837, filed Nov. 20, 2023, which is incorporated by reference as if disclosed herein in its entirety.

### STATEMENT REGARDING FEDERALLY SPONSORED RESEARCH OR DEVELOPMENT

This invention was made with government support under 2134488 awarded by the National Science Foundation. The government has certain rights in the invention.

### BACKGROUND

Earth architecture has been gaining renewed interest due its environmental benefits. In comparison to typical concrete building techniques, which is currently responsible for consuming 10% of global carbon emissions, earth construction makes use of locally available and minimally processed materials, reducing embodied energy demand by 38-83%, and embodied climate change potential by 60-82%.

In terms of applicability for 3D printing fabrication, earth materials offer responses to challenges posed for 3D printed concrete. The integration of vertical reinforcement in 3D printed concrete requires complex applications, and dispersed short steel, glass, and polymer fibers require further investigation. From an environmental standpoint, 3D printed concrete results in even higher carbon intensities than conventional concrete because it typically contains higher cement content to pass through the small pipe and nozzles at the print-head. Printed earth is vernacularly practiced with micro-scale vegetable fibers that provide increased ductility while also maximizing carbon storage of the mix design.

However, 3D printed earth mixture design research has been limited to mix designs that include low fiber content, such as cob mixtures. With high thermal capacity and low thermal resistivity, cob is limited by building codes to thick walls and is thus mostly suited warm-hot climates or as an assembly that is placed within the thermal envelope of a building. Light straw clay, a more promising carbon-storing building material, currently lacks advanced manufacturing techniques. As opposed to conventionally constructed earth materials, 3D printed earth includes mixtures with higher water content to reduce viscosity and facilitate the material extrusion, with 23-25% water. Previous research has shown challenges in increasing fiber content over 2% fiber in weight due to extrusion difficulties and increased viscosity that results in printing malfunction and clogging.

What is needed, therefore, is an improved 3D printed earth mixture that addresses at least the problems described above.

### SUMMARY

To address the problems described above, some embodiments of the present disclosure are directed to extrudable earth-fiber mixtures with bio-based additives, also referred to as 3D Printed Lite Clay, to provide enhanced thermal and structural properties for 3D printed lightweight architectural applications, as opposed to 3D printed cob. Increasing fiber content in digitally fabricated earth assemblies to have a mixture more similar to light straw clay increases the carbon storage during the embodied phase of the material, and, by reducing the conductivity of the assembly, decreases carbon emissions during the operational phase due to lower heating and cooling demand.

According to an embodiment of the present disclosure, a structure that includes a composition formed of a mixture is provided. The mixture includes an earth component, at least one fiber component, a fluid component, and at least one additive component. The structure is configured for use as a building element portion, such as structural, infill, brick, panels, insulation, interior, exterior, etc.

In some embodiments, the mixture includes weight ratio ranges of about 2-50 parts of the earth component, about 5-50 parts of at least one fiber component, about 25-80 parts of the fluid component, and about 0-10 parts of the at least one additive component.

In some embodiments, the earth component includes a naturally occurring soil, subsoil, topsoil, clay, a clay-rich soil, sand, silt, an engineered soil formed of sand and clay, or combinations thereof.

In some embodiments, the fiber component includes a bast or leaf fiber, including straw, wheat straw, rice straw, rice husk, reed, hay, hemp, kenaf, banana, sisal, fique, flax, jute, or combinations thereof.

In some embodiments, the fiber component includes a plurality of fibers having an average length between about 0.001 mm and about 60 mm.

In some embodiments, the fluid component includes water, oil, acid, or combinations thereof.

In some embodiments, the at least one additive component includes a bio-based additive such as cellulose, a polypeptide such as gelatin, a polysaccharide such as alginate, guar gum, locust bean gum, chitosan, and xanthan gum, and lime, or combinations thereof.

In some embodiments, the fiber component has a weight percent in the range of about 5% to about 50% of the mixture.

In some embodiments, the earth component has a weight percent in the range of about 2% to about 50% of the mixture.

In some embodiments, the at least one additive component has a weight percent in the range of about 0.01% to about 10% of the mixture.

In some embodiments, the at least one additive component has a weight percent in the range of about 0.1% to about 50% of the combined weight percents of the earth component and the fiber component.

In some embodiments, the structure includes an insulation portion and an exterior support portion surrounding the insulation portion.

In some embodiments, the structure forms a block-like geometry, a monolithic wall, a panel element, or any otherwise prefabricated building element.

In some embodiments, the structure is 3D-printed, mechanically compressed, or manually fabricated.

According to another embodiment of the present disclosure, a method of making the structure of any of the disclosed embodiments is provided. The method includes 3D-printing the structure with the mixture.

Further objects, aspects, features, and embodiments of the present technology will be apparent from the drawing Figures and below description.

### BRIEF DESCRIPTION OF DRAWINGS

Some embodiments of the present technology are illustrated as an example and arc not limited by the figures of the accompanying drawings, in which like references may indicate similar elements.

FIG. 1 is a perspective view of a 3D printed structure according to some embodiments of the disclosed subject matter;

FIG. 2 is a schematic representation of a method of making a structure according to some embodiments of the disclosed subject matter;

FIG. 3 is a perspective view of a process of 3D printing a structure according to some embodiments of the disclosed subject matter; and

FIGS. 4A-4C is a section view of 3 3D printing systems that are piston based (FIG. 4A) and screw based (FIGS. 4B-4C) that can be used to extrude the extrudable mixture according to some embodiments of the present disclosure.

### DETAILED DESCRIPTION

Accordingly, some embodiments of the disclosed subject matter are directed to extrudable earth-fiber mixtures with bio-based additives to provide enhanced thermal and structural properties over traditional 3D printed cob. Some embodiments of the disclosed subject matter are directed to a carbon-storing clay-fiber wall assembly from 3D printed earth (mass) and/or 3D printed vegetable fiber (insulation) with increased thermal and environmental performance compared to the incumbent assembly (a concrete masonry unit (CMU) wall). Earth materials combined with vegetable fibers offer a high performance, carbon-storing alternative to CMUs and synthetic insulation due to their carbon storage potential, affordability, safety, and wide range of hygrothermal capabilities. By using less processed materials for 3D printing, earth- and fiber-based building materials substantially reduce transportation, chemical treatments, excess manufacturing, warehouse storage, and intermediary storages that are inextricably intertwined with conventional highly processed materials. In some embodiments, the mixtures use biopolymer binding agents to develop mix designs for 3D printed earth while increasing fiber content, and thus, carbon storage and thermal resistivity. These embodiments link applied building technology research with digital fabrication (3D printing) and multi-scale thermal (and structural) investigations to reduce embodied emissions, increase the atmospheric carbon included in the finished product, and bolster commercialization potential of 3D printed residential construction. Additionally, embodiments of the disclosed subject matter support building policy and standardization by producing environmental and social life cycle assessments (ELCA and SLCA) that can be expanded into environmental and health product declarations (EPD and HPD).

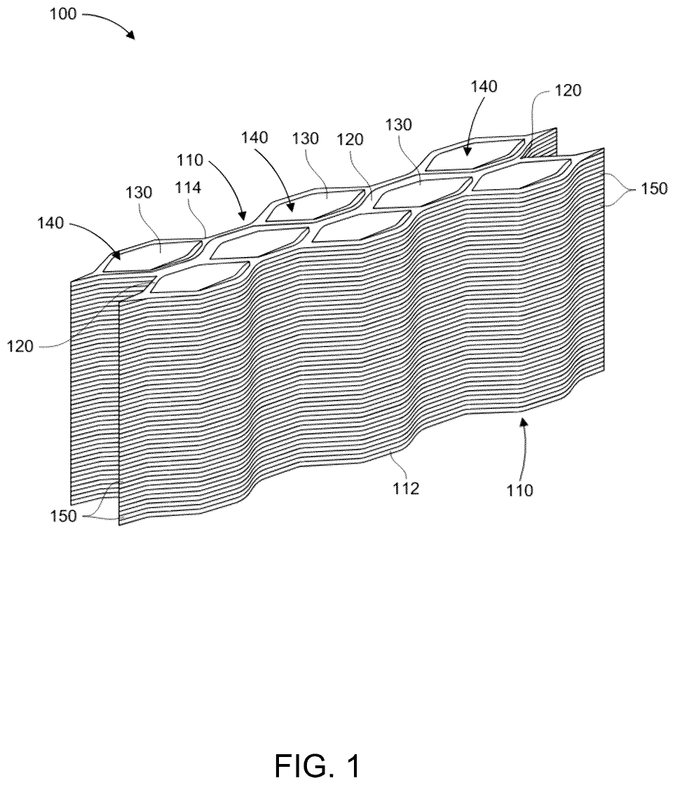

As shown in FIG. 1, a 3D printed structure according to some embodiments of the disclosed subject matter is generally designated by the numeral 100. The structure 100 includes a composition that is formed from a mixture. In some embodiments, the mixture includes an earth component, at least one fiber component, a fluid component, and at least one additive. In some embodiments, the earth component includes a naturally occurring soil, subsoil, topsoil, clay, a clay-rich soil, sand, silt, an engineered soil formed of sand and clay, or combinations thereof. In some embodiments, the fiber component includes a bast or leaf fiber, including straw, wheat straw, rice straw, rice husk, reed, hay, hemp, kenaf, banana, sisal, fique, flax, jute, or combinations thereof. In some embodiments, the fiber component includes a plurality of fibers having an average length between about 0.001 mm (e.g., ˜0 mm) and about 60 mm. In some embodiments, the plurality of fibers have an average length between about 0.01 mm and about 30 mm. In some embodiments, the plurality of fibers have an average length between about 4 mm and about 40 mm. In some embodiments, the plurality of fibers have an average length between about 1 mm and about 3 mm. In some embodiments, the plurality of fibers have an average length of about 3 mm. In some embodiments, the plurality of fibers have a length no greater than 3 mm. In some embodiments, the plurality of fibers have a uniform length (e.g., 4 mm, 40 mm, etc.). In some embodiments, the plurality of fibers are in a range of lengths. For example, in some embodiments, some of the plurality of fibers are in powdered form and some of the plurality of fibers are stalks of various lengths. In some embodiments, the at least one additive includes a bio-based additive such as cellulose, a polypeptide such as gelatin, a polysaccharide such as alginate, guar gum, locust bean gum, chitosan, and xanthan gum, and lime, or combinations thereof. In some embodiments, the fluid component includes water, oil, acid, or combinations thereof.

In some embodiments, the mixture includes weight ratio ranges of about 2-50 parts of the earth component, about 5-50 parts of the fiber component, about 25-80 parts of the fluid component, and about 0-10 parts of the additive component. In some embodiments, the fiber component has a weight percent in the range of about 5% to about 50% of the mixture. In some embodiments, the earth component has a weight percent in the range of about 2% to about 50% of the mixture. In some embodiments, the at least one additive component has a weight percent in the range of about 0% (e.g., about 0.0001% to about 0.01%) to about 10% of the mixture. In some embodiments, the at least one additive component has a weight percent in the range of about 0.1% to about 50% of the combined weight percents of the earth component and the fiber component. In some embodiments, the mixture includes about 20 to about 60 wt % earth component, about 1 to about 8 wt % at least one additive component, about 2 to about 50 wt % fiber component, and about 40 to about 80 wt % fluid component.

In some embodiments, the structure 100 includes an exterior support portion 110 and an insulation portion 130, as shown in FIG. 1. The exterior support portion 110 includes a first exterior wall 112 at a first side of the structure 100 and a second exterior wall 114 at a second side of the structure 100. The insulation portion 130 is positioned between the first exterior wall 112 and the second exterior wall 114 such that the exterior support portion 110 surrounds the insulation portion 130. In some embodiments, the structure 100 includes an interior support portion 120 that is positioned between the first exterior wall 112 and the second exterior wall 114 and partially surrounds the insulation portion 130. In some embodiments, the interior support portion 120 has a substantially double-helical shape and is positioned between the first exterior wall 112 and the second exterior wall 114 thereby forming a plurality of pockets 140 within the structure 110, as shown in FIG. 1. In such embodiments, the insulation portion 130 is positioned in each of the plurality of pockets 140. In some embodiments, the structure 100 is 3D printed as a plurality of layers 150 stacked on top of one another. In some embodiments, the plurality of layers 150 have a height between about 3 mm and about 5 mm. In some embodiments, the plurality of layers 150 have a height of about 4 mm. In some embodiments, the structure 100 is formed as a building element portion, such as a block-like geometry, a monolithic wall, a panel element, or any otherwise prefabricated building element portion.

The exterior support portion 110, the interior support portion 120, and the insulation portion 130 from using any combination of the mixtures formed disclosed herein. By way of example, in some embodiments, the exterior support portion 110 is formed of a cob mixture, the interior support portion 120 is formed of a light cob mixture, and the insulation portion 130 is formed of a light straw clay mixture, each mixture having the components and weight percentages discussed herein.

In some embodiments, the mixture is a cob mixture that includes about 54 wt % clay-rich soil, about 1 wt % methylcellulose, about 1 wt % sodium alginate, about 3 wt % straw, and about 41 wt % water. In some embodiments, the mixture is a light cob mixture that includes about 45 wt % clay-rich soil, about 1 wt % methylcellulose, about 1 wt % sodium alginate, about 8 wt % straw, and about 45 wt % water. In some embodiments, the mixture is a light straw clay mixture that includes about 3 wt % clay-rich soil, about 2 wt % methylcellulose, about 2 wt % sodium alginate, about 13 wt % straw, and about 79 wt % water. In some embodiments, the mixture is an extra light straw clay mixture that includes about 6 wt % clay-rich soil, about 3 wt % methylcellulose, about 3 wt % sodium alginate, about 17 wt % straw, and about 70 wt % water. In some embodiments, the mixture is a light banana clay mixture that includes about 16 wt % clay-rich soil, about 2 wt % methylcellulose, about 2 wt % sodium alginate, about 1 wt % locust beam gum, about 11% banana fibers, and about 68 wt % water. In some embodiments, the mixture is a light kenaf clay mixture that includes about 16 wt % clay-rich soil, about 2 wt % methylcellulose, about 2 wt % sodium alginate, about 1 wt % locust beam gum, about 11% kenaf fibers, and about 68 wt % water. In some embodiments, the mixture is a light hemp clay mixture that includes about 27 wt % clay-rich soil, about 2 wt % methylcellulose, about 2 wt % sodium alginate, about 1 wt % locust beam gum, about 8 wt % hemp fibers, and about 60 wt % water.

In some embodiments, the mixture includes up to about 50 wt % of the fiber component. In some embodiments, the earth component includes about 0.1 to about 5 wt % of a clay for pigmentation purposes (such as a natural red clay). In some embodiments, the at least one additive includes a cellulose and an alginate such that the mixture has a cellulose: alginate weight percent ratio of about 1:1. In some embodiments, the mixture has an earth: fiber: additive: fluid weight percent ratio of about 3:13:4:79.

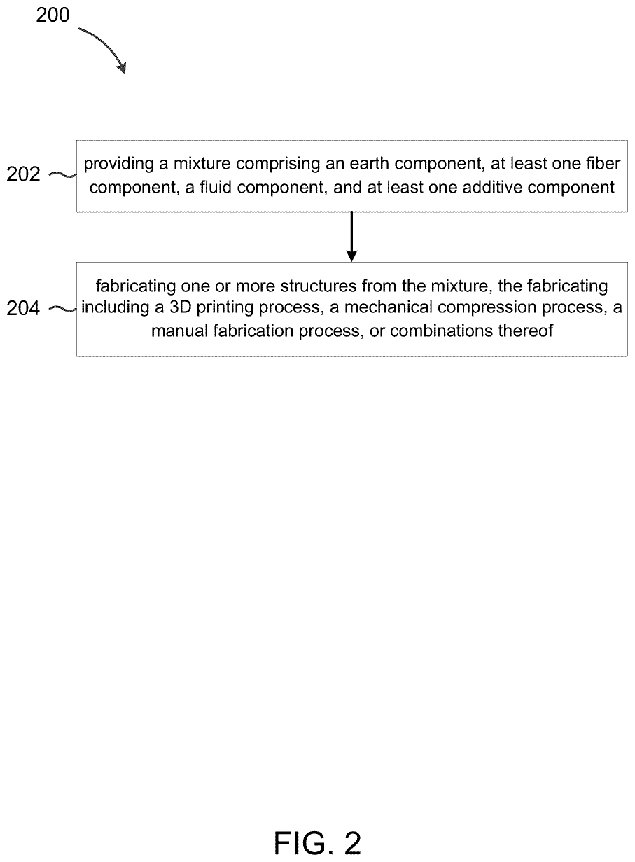

Referring now to FIG. 2, some embodiments of the present disclosure are directed to a method 200 of making a structure. In some embodiments, at 202, a mixture is provided. As discussed above, in some embodiments, the mixture includes an earth component, at least one fiber component, a fluid component; and at least one additive component. In some embodiments, the earth component comprises a naturally occurring soil, subsoil, topsoil, clay, a clay-rich soil, sand, silt, an engineered soil formed of sand and clay, or combinations thereof. In some embodiments, the fiber component comprises a bast or leaf fiber, including straw, wheat straw, rice straw, rice husk, reed, hay, hemp, kenaf, banana, sisal, fique, flax, jute, or combinations thereof. In some embodiments, the fiber component further comprises a plurality of fibers having an average length between about 0.001 mm and about 60 mm. In some embodiments, the fluid component comprises water, oil, acid, or combinations thereof. In some embodiments, the at least one additive component comprises a bio-based additive such as cellulose, a polypeptide such as gelatin, a polysaccharide such as alginate, guar gum, locust bean gum, chitosan, and xanthan gum, and lime, or combinations thereof.

As discussed above, mixture comprises a weight ratio of earth component: fiber component: fluid component: additive component. In some embodiments, the mixture includes about 2-50 parts of the earth component. In some embodiments, the mixture includes about 5-50 parts of the fiber component. In some embodiments, the mixture includes about 25-80 parts of the fluid component. In some embodiments, the mixture includes about 0-10 parts of the at least one additive component. In some embodiments, the mixture includes about 2-50 parts of the earth component; about 5-50 parts of the fiber component; about 25-80 parts of the fluid component; and about 0-10 parts of the at least one additive component. In some embodiments, the additive component has a weight percent in the range of about 0.1% to about 50% of the combined weight percents of the earth component and the fiber component. In some embodiments, the additive component has a weight percent in the range of about 0.01% to about 10% of the mixture.

Still referring to FIG. 2, at 204, one or more structures are fabricated from the mixture. In some embodiments, the structures form a block-like geometry, a monolithic wall, a panel element, or any otherwise prefabricated building element. In some embodiments, fabrication 204 includes a 3D printing process, a mechanical compression process, a manual fabrication process, or combinations thereof,

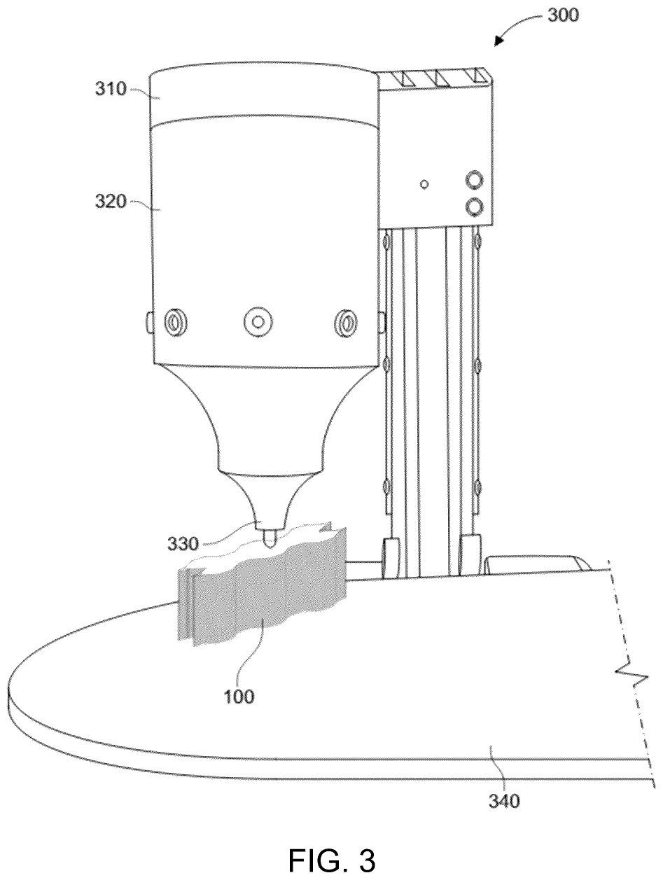

FIG. 3 shows a 3D printing process of making the structure 100 via a 3D printer 300 according to some embodiments of the disclosed subject matter. The 3D printer 300 includes a feed tube 310 having a 3D printing filament 320 housed therein. The 3D printing filament 320 includes the mixture discussed herein regarding structure 100. A nozzle 330 is connected to the feed tube 310, and the 3D printing filament 320 is extruded out through the nozzle 330 onto a print bed 340 to form the structure 100. In some embodiments, the nozzle 330 has an 8 mm wide opening for extrusion. However, in some embodiments, the nozzle 330 has a different sized opening, such as 4 mm, 5 mm, 6 mm, or between 8 to 30 mm. In some embodiments, the print bed 340 can be lowered as each layer is 3D printed and the print bed 340 can be translated and/or rotated such that the 3D printing can follow predetermined printing paths to form the structure 100. In some embodiments, the print bed 340 remains stationary and the feed tube 310 and nozzle 330 can be raised as each layer is 3D printed and feed tube 310 and nozzle 330 can be translated and/or rotated such that the 3D printing can follow the predetermined printing paths.

Some embodiments of the present disclosure include processing of earth-fiber mix-designs for 3D printing structures and elements, including fiber preparation. In some embodiments, the fiber preparation process involves the shredding and subsequent sifting of fibers to improve their compatibility with the extrusion system. In some embodiments, fibers are first shredded to achieve a uniform or substantially uniform consistency. In some embodiments, following the shredding, fibers are sifted to break electrostatic adhesion and to ensure a uniform distribution, removing fibers that could interfere with the extrusion pathway. In some embodiments, fibers longer than one-half of the nozzle diameter are identified and separated, as these dimensions ensure smoother passage through the nozzle and extrusion pathway. This controlled fiber sizing process enhances the overall consistency and performance of the extruded material, improving precision and quality in the final product.

Some embodiments of the present disclosure include processing of earth-fiber mix-designs for 3D printing structures and elements, including procedures for earth preparation and processing. In some embodiments, the earth component is poured in containers and then is fully covered with water. In some embodiment, a sieve, e.g., of 425 μm, is then used to gradually scoop the earth and eliminate the bigger aggregates while allowing finer particles to pass through. While submerged, sifted earth naturally settles at the bottom of the container, and the clean water is gradually removed from the upper level. In some embodiments, the settled earth is allowed to resettle if cloudiness appears. In some embodiments, once most water has been removed, grid-like pockets are applied into the soil, e.g., with a stick, to increase airflow to all layers, which accelerates drying. Fans can further expedite drying once the earth is no longer submerged. In some embodiments, the earth is dried in a cool, dry area for a predetermined length of time, e.g., 7 to 30 days. After drying, the earth can be pass through the sieve to separate finer particles ready to be used in the mixture.

In one embodiment of the present disclosure, when fibers and the liquid are mixed beforehand, the following methodology is followed. Fibers are first sifted and soaked with the designated amount of liquid for an average duration of 5 hours to create the wet mixture. In parallel, the biopolymers and the earth are mixed together in a separate container to create the dry mix. After 5 hours, the wet mixture of fibers and liquid is transferred into a mixing machine and mixed for 5 minutes. The dry mixture is then divided into 5 portions, which are added consecutively to be mixed to ensure the paste is well homogenized. For each addition of the dry mixture, the combined mixture is mixed for at least 5 minutes. Once the paste is ready, it is rolled, e.g., manually, to fit the cylindrical shape of the 3D printer cartridge and to minimize air gaps or in the fabrication means used. A fan is positioned and activated towards the object being 3D printed or fabricated to increase printing stability.

In one embodiment of the present disclosure, when additives, e.g., biopolymers, and the liquid are mixed beforehand, the following methodology is followed. Biopolymers are mixed with the designated amount of the liquid to be hydrated and create a wet mixture in a mixing machine for 5 minutes. In parallel, the fibers and the earth are mixed together in a separate container to create the dry mix. The dry mixture is then divided into 5 portions, which are added consecutively to ensure the paste is well homogenized. For each addition of the dry mixture, the combined mixture is mixed for at least 5 minutes. Once the printing paste is ready, it is rolled, e.g., manually, to fit the cylindrical shape of the 3D printer cartridge and to minimize air gaps or in the fabrication means used. A fan is positioned and activated towards the object being 3D printed or fabricated to increase printing stability.

In embodiments where locust bean gum is used as one of the biopolymers, for both methodologies described above, the biopolymer can be prepared separately, e.g., it is blended with water using a high-speed mixer to create a stable emulsion for at least 5 minutes, and this emulsion is then introduced into the main mixture, allowing for improved bonding and uniformity across the composite material.

In embodiments where the mixture is manually mixed, each batch can be prepared individually, with quantities designed to fill one 3D printer tube per mix design or according to the fabrication means used. The consistent texture is manually achieved throughout the mixing, ensuring no significant clumps formed across the five portions. This process, with constant attention to texture, can take more than 25 minutes per batch for one person. When the mixture is electrically powered mixed with a machine, such as a planetary stand mixer or a laboratory cement mixer, these machines can be set to the lower speed.

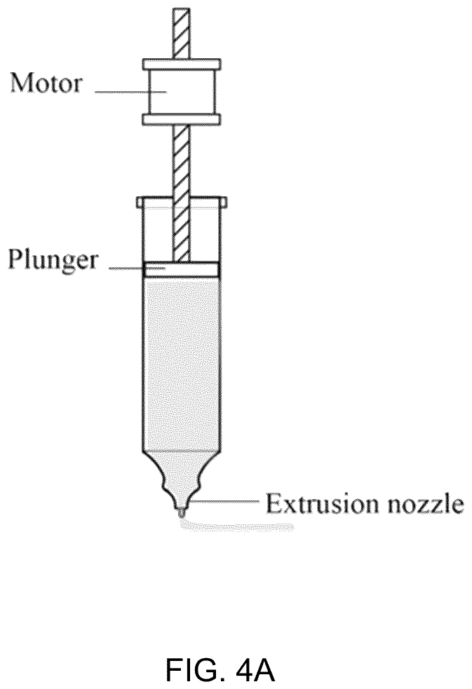

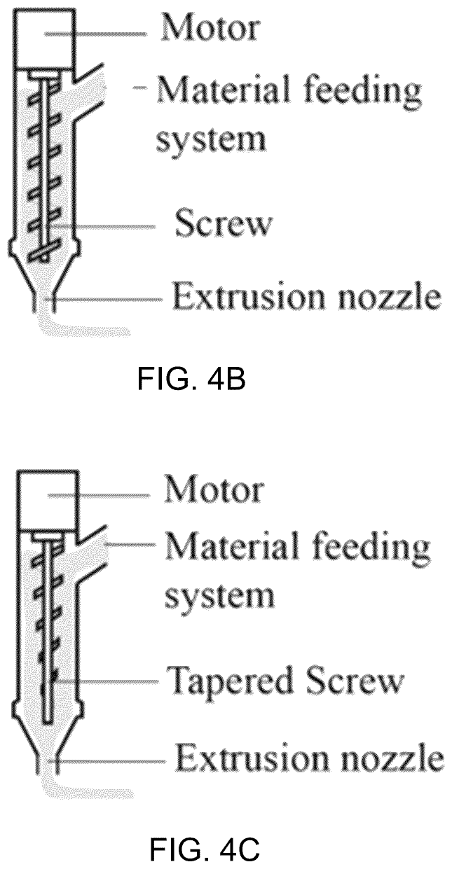

FIGS. 4A-4C illustrates three extrusion printing systems that are applicable for extruding material mixtures consistent with embodiments of the present disclosure. FIG. 4A is a piston-based extrusion system consistent with some embodiments of present disclosure. FIGS. 4B-4C include screw-based extrusion systems (untouched screw in FIG. 4B, tapered screw in FIG. 4C) consistent with embodiments of the present disclosure. The fiber-rich paste can be used for both piston-based and screw-based extrusion printers. When using a screw-based system, the screw may be tapered, with a smaller diameter at the level of the extrusion nozzle, to prevent fiber clogging during the extrusion process. The printing speed can range between 1000mm/sec and 4000 mm/sec for both systems. In embodiments where compressed air is employed to drive the material through the feeding system, the pressure can be set between 2 kPa and 6 kPa.

As will be apparent to those skilled in the art, various modifications, adaptations, and variations of the foregoing specific disclosure can be made without departing from the scope of the technology claimed herein. The various features and elements of the technology described herein may be combined in a manner different than the specific examples described or claimed herein without departing from the scope of the technology. In other words, any element or feature may be combined with any other element or feature in different embodiments, unless there is an obvious or inherent incompatibility between the two, or it is specifically excluded. The term “and/or” means any one of the items, any combination of the items, or all of the items with which this term is associated. The phrase “one or more” is readily understood by one of skill in the art, particularly when read in context of its usage. Each numerical or measured value in this specification is modified by the term “about.” The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

What is claimed is:

1. A structure including a composition formed from a mixture comprising:
an earth component;
at least one fiber component;
a fluid component; and
at least one additive component;
wherein the mixture comprises a weight ratio of earth component: fiber component: fluid component: additive component of:
about 2-50 parts of the earth component;
about 5-50 parts of the fiber component;
about 25-80 parts of the fluid component; and
about 0-10 parts of the at least one additive component.

2. The structure of claim 1, wherein the earth component comprises a naturally occurring soil, subsoil, topsoil, clay, a clay-rich soil, sand, silt, an engineered soil formed of sand and clay, or combinations thereof.

3. The structure of claim 1, wherein the fiber component comprises a bast or leaf fiber, including straw, wheat straw, rice straw, rice husk, reed, hay, hemp, kenaf, banana, sisal, fique, flax, jute, or combinations thereof.

4. The structure of claim 3, wherein the fiber component further comprises a plurality of fibers having an average length between about 0.001 mm and about 60 mm.

5. The structure of claim 1, wherein the fluid component comprises water, oil, acid, or combinations thereof.

6. The structure of claim 1, wherein the at least one additive component comprises a bio-based additive such as cellulose, a polypeptide such as gelatin, a polysaccharide such as alginate, guar gum, locust bean gum, chitosan, and xanthan gum, and lime, or combinations thereof.

7. The structure of claim 1, wherein the at least one additive component has a weight percent in the range of about 0.01% to about 10% of the mixture.

8. The structure of claim 1, wherein the at least one additive component has a weight percent in the range of about 0.1% to about 50% of the combined weight percents of the earth component and the fiber component.

9. The structure of claim 1, wherein the structure comprises an insulation portion and an exterior support portion surrounding the insulation portion.

10. The structure of claim 1, wherein the structure forms a block-like geometry, a monolithic wall, a panel element, or any otherwise prefabricated building element.

11. A method of making a structure, comprising:
providing a mixture, comprising:
an earth component;
at least one fiber component;
a fluid component; and
at least one additive component; and,
fabricating one or more structures from the mixture, the fabricating including a 3D printing process, a mechanical compression process, a manual fabrication process, or combinations thereof,
wherein the mixture comprises a weight ratio of earth component: fiber component: fluid component: additive component of:
about 2-50 parts of the earth component;
about 5-50 parts of the fiber component;
about 25-80 parts of the fluid component; and
about 0-10 parts of the at least one additive component.

12. The method of claim 11, wherein the earth component comprises a naturally occurring soil, subsoil, topsoil, clay, a clay-rich soil, sand, silt, an engineered soil formed of sand and clay, or combinations thereof.

13. The method of claim 11, wherein the fiber component comprises a bast or leaf fiber, including straw, wheat straw, rice straw, rice husk, reed, hay, hemp, kenaf, banana, sisal, fique, flax, jute, or combinations thereof.

14. The method of claim 13, wherein the fiber component further comprises a plurality of fibers having an average length between about 0.001 mm and about 60 mm.

15. The method of claim 11, wherein the fluid component comprises water, oil, acid, or combinations thereof.

16. The method of claim 11, wherein the at least one additive component comprises a bio-based additive such as cellulose, a polypeptide such as gelatin, a polysaccharide such as alginate, guar gum, locust bean gum, chitosan, and xanthan gum, and lime, or combinations thereof.

17. The method of claim 11, wherein the at least one additive component has a weight percent in the range of about 0.01% to about 10% of the mixture.

18. The method of claim 11, wherein the at least one additive component has a weight percent in the range of about 0.1% to about 50% of the combined weight percents of the earth component and the fiber component.

19. The method of claim 11, wherein the structure forms a block-like geometry, a monolithic wall, a panel element, or any otherwise prefabricated building element.

20. A structure including a composition formed from a mixture comprising:
an earth component including a naturally occurring soil, subsoil, topsoil, clay, a clay-rich soil, sand, silt, an engineered soil formed of sand and clay, or combinations thereof;
a fiber component including a bast or leaf fiber, including straw, wheat straw, rice straw, rice husk, reed, hay, hemp, kenaf, banana, sisal, fique, flax, jute, or combinations thereof;
a fluid component including water, oil, acid, or combinations thereof; and
at least one additive component including a bio-based additive such as cellulose, a polypeptide such as gelatin, a polysaccharide such as alginate, guar gum, locust bean gum, chitosan, and xanthan gum, and lime, or combinations thereof, wherein the mixture comprises a weight ratio of earth component: fiber component: fluid component: additive component of:
about 2-50 parts of the earth component;
about 5-50 parts of the fiber component;
about 25-80 parts of the fluid component; and
about 0-10 parts of the at least one additive component, and
wherein the structure is a block-like geometry. a monolithic wall, a panel element. or any otherwise prefabricated building element that is fabricated via including a 3D printing process, a mechanical compression process, a manual fabrication process, or combinations thereof.
